(19) United States
(12) Patent Application Publication
(10) Pub. No.: US 2002/0172381 A1
(43) Pub. Date: Nov. 21, 2002

(54) Piezoelectric microphone

(76) Inventor: Hvo-Sheng Wang, Pan Chiao City (TW)

Correspondence Address: BACON & THOMAS, PLLC, 625 Slaters Lane, 4th Floor, Alexandria, VA, 22314-1176, US

(21) Appl. No.: 09/855,491

(22) Filed: May 16, 2001

(51) Int. Cl. H04R 25/00

(52) U.S. Cl. 381/173; 381/190

(57) ABSTRACT

A piezoelectric microphone comprises a band, a cable, a voice receiving device in contact with a voice source being connected to one ends of band and cable, a plug at the other end of cable, and a voice output device. Microphone is held to a voice source by band. Sound waves from the voice source are converted into a signal in the voice receiving device prior to sending to the voice output device through cable. Then the signal is converted into voice in voice output device for output. With this, outside sound is prevented from coming through the voice receiving device. That is, outside sound can not be transmitted to voice output device through voice receiving device and cable. Hence, the voice receiving device only receives sound waves from the voice source, resulting in a clear voice output through the microphone.

### FIELD OF THE INVENTION

The present invention relates to microphones and more particularly to a piezoelectric microphone with improved characteristics.

### BACKGROUND OF THE INVENTION

A conventional contact microphone comprises a band, a voice receiving device at one end of band, a cable having one end connected to the a voice receiving device, a plug connected to the other end of the cable, and a voice output device connected to the plug. Band is secured to a voice source. Hence, voice receiving device is disposed near voice source. The sound waves from voice source are converted into an electrical signal by voice receiving device. Signal is in turn transmitted to voice output device through the cable for converting into sound waves for output.

But this is unsatisfactory for the purpose for which the invention is concerned because microphone is not in close proximity to voice source. Thus, sound waves from voice source are not completely transmitted to voice receiving device which in turn causes the sound output of voice output device to be somewhat disturbed, resulting in an undistinguished sound.

Moreover, in another conventional design a hands-free device for a mobile phone comprises a first cable, an earphone at one end of first cable, a second cable, a mouthpiece at one end of second cable, and a plug at the other end of second cable being capable of inserting into the jack of mobile phone. Hence, signal from mobile phone is sent to earphone through first cable for converting into sound waves for output. Further, the sound waves of user voice are converted into an electrical signal by mouthpiece which in turn is sent to mobile phone through second cable.

However, the previous design suffered from several disadvantages. For example, not only voice spoken by user may input mobile phone through mouthpiece and second cable, but also outside sound (i.e., noise) may input mobile phone through mouthpiece and second cable. As such, a person who receives a call may hear voice of another person who makes a phone call as well as the added noise. This may significantly degrade the voice quality and thus the person who receives the call may not hear voice clearly. To the worse, a person who uses the mobile phone while driving may hardly hear the voice transmitted from earpiece due to a strong noise generated by for example, engine, stereo, wind, etc.

### SUMMARY OF THE INVENTION

It is an object of the present invention to provide a piezoelectric microphone comprising a band, a cable, a voice receiving device in contact with a voice source being connected to one ends of band and cable, a plug at the other end of cable, and a voice output device. Microphone is held to a voice source by band. Sound waves from the voice source are converted into a signal in the voice receiving device prior to sending to the voice output device through cable. Then the signal is converted into voice in voice output device for output. With this, outside sound is prevented from coming through the voice receiving device. That is, outside sound can not be transmitted to voice output device through voice receiving device and cable. Hence, the voice receiving device only receives sound waves from the voice source, resulting in a clear voice output through the microphone.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of piezoelectric microphone according to the invention;

FIG. 2 is an exploded view of voice receiving device of FIG. 1; and

FIG. 3 is a cross-sectional view of the assembled voice receiving device of FIG. 2.

### DETAILED DESCRIPTION OF THE PREFERRED EMBODIMENTS

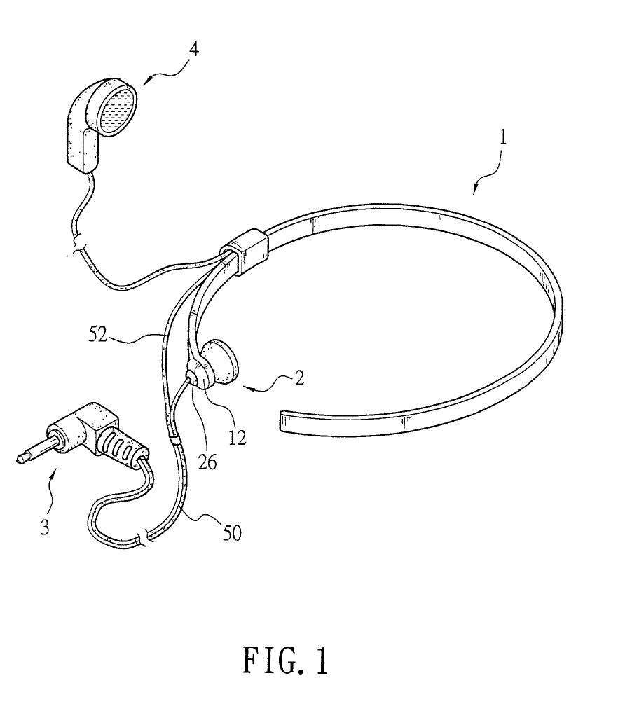

Referring to the accompanying drawings and particularly to FIG. 1, there is shown a piezoelectric microphone in accordance with the invention comprising a band 1, a first cable 50, a voice receiving device 2 connected to one ends of band 1 and first cable 50, and a plug 3 at the other end of first cable 50. Microphone is held to a voice source (not shown) by band 1. While voice source is the throat of user in this embodiment, it may be replaced by another suitable device without departing from the scope and spirit of the invention. As such, voice receiving device 2 may contact the voice source. Sound waves from the voice source are converted into an electrical signal by voice receiving device 2. The signal is in turn sent to first cable 50. Then signal is sent to a voice output device through plug 3. While voice output device is a loudspeaker or a mobile phone in this embodiment, it may be replaced by another suitable device without departing from the scope and spirit of the invention. Finally, signal is converted into sound waves in the voice output device for output.

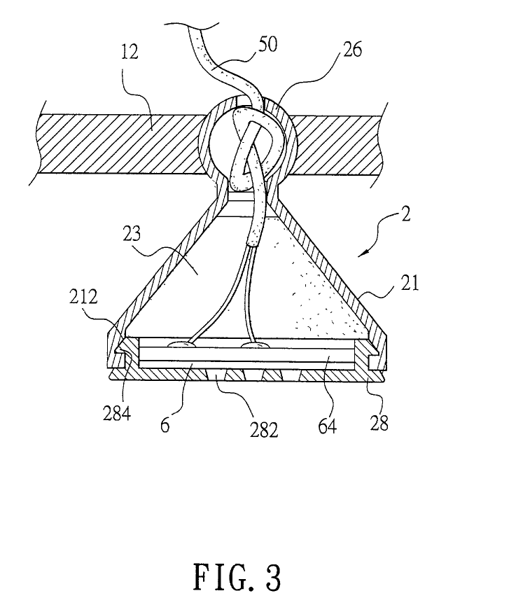

Referring to FIGS. 1 and 3 specifically, the telescopic band 1 comprises a fixed section and a sliding section in which the sliding section is capable of retracting into or extending from the fixed section so as to adjust the size of band 1 for being adapted to the attached device.

Voice receiving device 2 is pivotal about band 1 and comprises a cone-shaped first housing 21 having a first latched member 212 inside the lower peripheral edge and a round-shaped second housing 28 at the bottom having a plurality of inverse cone-shaped holes 282 and an upward protruded mating second latched member 284 at peripheral edge in which first 212 and second latched members 212 and 284 are snapped to secure first and second housings 21 and 28 together.

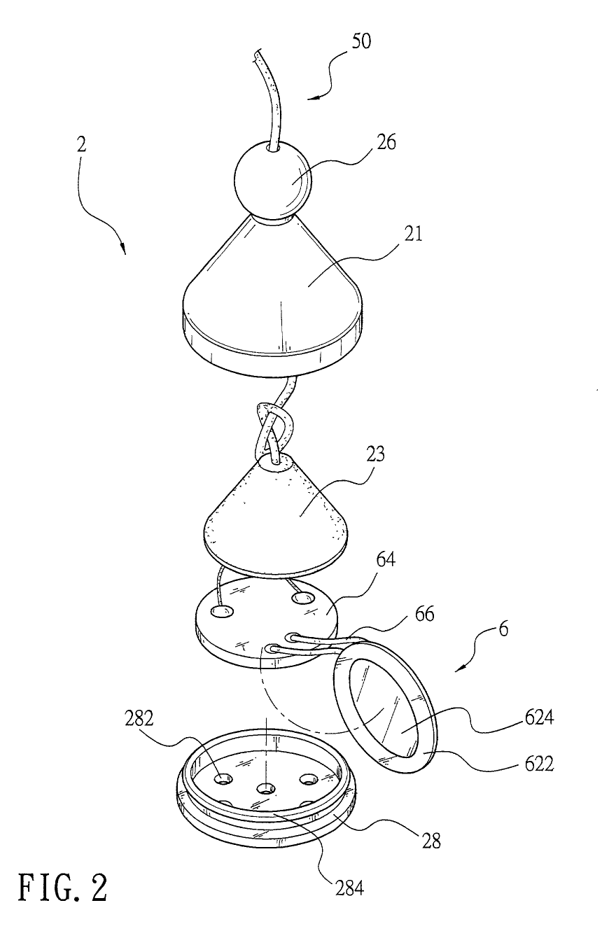

Referring to FIGS. 2 and 3 specifically, a piezoelectric buzzer 6 and a circuit board 64 are provided between first and second housings 21 and 28. Piezoelectric buzzer 6 is connected to circuit board 64 through a pair of leads 66. Piezoelectric buzzer 6 is a rounded plate below and abutted on the bottom of circuit board 64. Piezoelectric buzzer 6 comprises a first thin metal plate 622 and a second thin metal plate 624 surrounded by first thin metal plate 622. A cushion 23 is above the circuit board 64. While cushion 23 is a foam in this embodiment, it may be replaced by another suitable device without departing from the scope and spirit of the invention. In operation, sound waves are passed through holes 282 to reach first and second thin metal plates 622 and 624. Then sound waves are transmitted to circuit board 64 through leads 66. Finally, sound waves are converted into an electrical signal in circuit board 64 prior to outputting. Note that cushion 23 acts to lessen the shock of sound waves for substantially eliminating sound waves transmitted to first and second housings 21 and 28.

One end of first cable 50 is connected to circuit board 64, while the other end thereof is passed through top of first housing 21. Referring to FIG. 1 specifically, as stated above, plug 3 is connected to the other end of first cable 50. Plug 3 is in turn connected to voice output device. Hence, signals from circuit board 64 are sent to voice output device through first cable 50. Finally, signals are converted into voice in the voice output device for output.

Referring to FIG. 1 again, a preferred embodiment of piezoelectric microphone according to the invention is illustrated. A second cable 52 is provided and has one end connected to plug 3 and the other end connected to an earphone 4. Hence, signals from voice output device are sent to earphone 4 through second cable 52. Finally, signals are converted into voice in earphone 4 for output. A coupling member 12 is provided at one end of band 1 having a central hole (not shown). A universal joint 26 is provided on top of first housing 21 being inserted in and pivotally attached to the central hole of coupling member 12. As such, voice receiving device 2 is adapted to rotate for adjusting its angle.

In operation, plug 3 is inserted into a voice output device (e.g., mobile phone). Microphone is held to a voice source (e.g., the neck of user) by band 1. Then rotate the universal joint 26 to adjust the angle of voice receiving device 2. Voice receiving device 2 is in contact with voice source. Sound waves from the voice source are sent to the voice output device to output voice through the voice receiving device 2 and first cable 50, while signals from voice output device are sent to earphone 4 through second cable 52. Hence, outside sound (i.e., noise) is prevented from coming through the voice receiving device 2. That is, outside sound can not be transmitted to voice output device through voice receiving device 2 and first cable 50. Thus, the voice receiving device 2 only receives sound waves from the voice source, resulting in a clear voice output through the microphone.

While the invention has been described by means of specific embodiments, numerous modifications and variations could be made thereto by those skilled in the art without departing from the scope and spirit of the invention set forth in the claims.

What is claimed is:

1. A piezoelectric microphone comprising: a band;
a voice receiving means pivotally attached to one end of said band and including a first housing and a second housing secured to said first housing;
a piezoelectric buzzer and a circuit board both disposed between said first and said second housings;
a pair of leads connected between said piezoelectric buzzer and said circuit board;
a plug;
a first cable having one end connected to said circuit board and said other end passed through said first housing for connecting to said plug; and
a voice output means connected to said plug.

2. The piezoelectric microphone of claim 1, wherein said piezoelectric buzzer consists of a first thin metal plate and a second thin metal plate surrounded by said first thin metal plate.

3. The piezoelectric microphone of claim 1, wherein said second housing comprises a plurality of inverse cone-shaped holes therethrough.

4. The piezoelectric microphone of claim 1, wherein said first housing comprises a first latched member inside a lower peripheral edge thereof and said second housing comprises a protruded mating second latched member at a peripheral edge thereof snapped to said first latched member for securing said first and said second housings together.

5. The piezoelectric microphone of claim 1, further comprising an earphone and a second cable having one end connected to said plug and said other end connected to said earphone so that a signal from said voice output means is sent to said earphone through said second cable and said signal is subsequently converted into voice in said earphone for output.

6. The piezoelectric microphone of claim 1, further comprising a cushion on one side of said circuit board opposite to said piezoelectric buzzer.

7. The piezoelectric microphone of claim 1, further comprising a coupling member at one end of said band having a central hole thereon, and a universal joint on said top of said first housing being inserted in said central hole, so that said voice receiving means is adapted to rotate for adjusting an angle thereof.

8. The piezoelectric microphone of claim 1, wherein said band member is telescopic and comprises a fixed section and a sliding section capable of retracting into or extending from said fixed section for adjusting said size of said band.
